(19) United States
(12) Patent Application Publication
(10) Pub. No.: US 2025/0196024 A1
(43) Pub. Date: Jun. 19, 2025

(54) PREPARATIVE CHROMATOGRAPH SYSTEM

(71) Applicant: SHIMADZU CORPORATION, Kyoto (JP)

(72) Inventors: Takayuki IRIKI, Kyoto (JP); Soichiro TAMAOKI, Kyoto (JP); Shiori UEDA, Kyoto (JP); Tatsuya OBE, Kyoto (JP)

(73) Assignee: SHIMADZU CORPORATION, Kyoto (JP)

(21) Appl. No.: 18/947,235

(22) Filed: Nov. 14, 2024

(30) Foreign Application Priority Data
Dec. 13, 2023 (JP) 2023-209852

(51) Int. Cl. B01D 15/24; B01D 15/14

(52) U.S. Cl. CPC B01D 15/247; B01D 15/14; B01D 2259/40043

(57) ABSTRACT

A preparative chromatograph system (1) includes a fractionation collecting condition correction part (18) configured to detect a change in a chromatogram acquired in each of a plurality of injections of a sample during stack injection fractionation collecting and to correct a fractionation collecting condition during the stack injection fractionation collecting so that the chromatogram approaches a state before the change, wherein the stack injection fractionation collecting continues based on the corrected fractionation collecting condition after the fractionation collecting condition correction part (18) has corrected the fractionation collecting condition.

### BACKGROUND OF THE INVENTION

### 1. Field of the Invention

The present invention relates to a preparative chromatograph system.

### 2. Description of the Related Art

A preparative chromatograph including a preparative liquid chromatograph (hereinafter, preparative LC) and a preparative supercritical fluid chromatograph (hereinafter, preparative SFC) is a device that separates a plurality of components in a sample from each other through chromatography using a liquid or a supercritical fluid and collects the separated individual components in individual containers with a fraction collector.

In purification using a preparative chromatograph, stack injection is widely used to improve throughput (see JP 2023-117066 A). In the stack injection, the same sample is injected into a mobile phase multiple times at regular time intervals.

### SUMMARY OF THE INVENTION

In the fractionation collecting of components using stack injection in which the same sample is injected at regular time intervals (hereinafter, referred to as stack injection fractionation collecting), high reproducibility is required for the chromatogram obtained by each injection, but the retention time of the peak changes because of fluctuations in the room temperature, an increase in the pump pressure, and the like, and the reproducibility of the chromatogram may deteriorate. When the reproducibility of the chromatogram has decreased, problems such as insufficient separation of a sample and a decrease in the recovery rate of components occur. In addition, when the delay in the retention time of the peak of the chromatogram increases, the peak of the sample injected this time and the peak of the sample injected next may overlap with each other.

The present invention has been made in view of the above problems, and an object of the present invention is to suppress a decrease in reproducibility of a chromatogram in stack injection fractionation collecting.

A preparative chromatograph system according to the present invention includes:
a liquid feeding pump that feeds a mobile phase;
an autosampler that is provided downstream of the liquid feeding pump and is configured to inject a sample into the mobile phase;
a separation column provided downstream of the autosampler for separating a plurality of components in the sample from each other;
a detector provided downstream of the separation column for obtaining a chromatogram of an eluate from the separation column;
a fraction collector provided with a plurality of collection containers, the fraction collector being configured to collect fractions of the eluate from the separation column in the plurality of collection containers;
a controller configured to execute stack injection fractionation collecting of injecting a same sample a plurality of times at a time interval set in advance and fractionation collecting the components in the injected sample by controlling operations of the liquid feeding pump, the autosampler, and the fraction collector according to a fractionation collecting condition set in advance; and
a fractionation collecting condition correction part configured to detect a change in the chromatogram acquired in each of a plurality of injections of the sample during the stack injection fractionation collecting and to correct the fractionation collecting condition during the stack injection fractionation collecting such that the chromatogram approaches a state before the change,
wherein the controller is configured to continue the stack injection fractionation collecting based on the fractionation collecting condition that has been corrected after the fractionation collecting condition correction part has corrected the fractionation collecting condition.

With the preparative chromatograph system according to the present invention, a change in the chromatogram acquired in each of a plurality of injections of a sample is detected during stack injection fractionation collecting, a fractionation collecting condition is corrected during the stack injection fractionation collecting so that the chromatogram approaches a state before the change, and the stack injection fractionation collecting continues based on the corrected fractionation collecting condition after the fractionation collecting condition is corrected. Thus, a decrease in reproducibility of the chromatogram obtained by each injection is suppressed.

### BRIEF DESCRIPTION OF THE DRAWINGS

FIG. 1 is a schematic configuration diagram illustrating an embodiment of a preparative chromatograph system;

FIG. 2 is a flowchart illustrating an example of the operation of the embodiment;

FIG. 3 is a diagram for describing an example of correction of a fractionation collecting condition;

FIG. 4 is a diagram illustrating a use example of a collection container set in a fraction collector;

FIG. 5 is a diagram for describing a collection container to be newly used when the collection container in use is full; and

FIG. 6 is a diagram for describing an example of correction of a purge time.

### DETAILED DESCRIPTION OF THE INVENTION

Hereinafter, an embodiment of a preparative chromatograph system will be described with reference to the drawings.

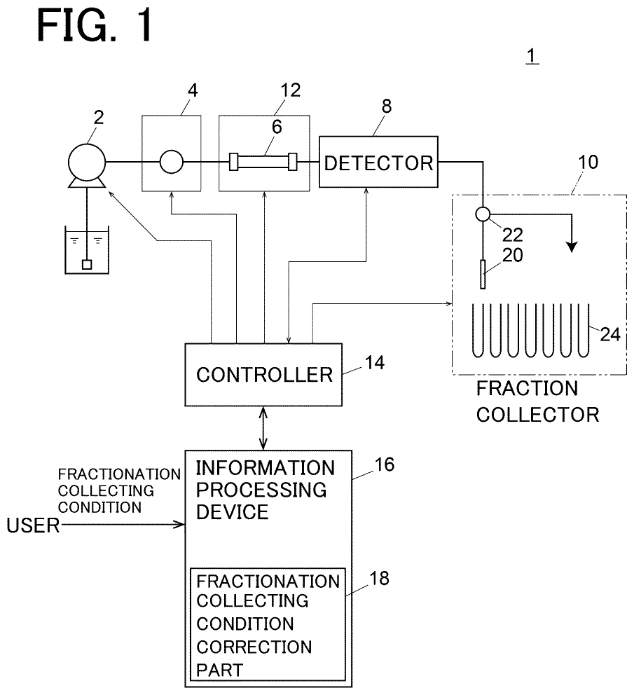

As illustrated in FIG. 1, a preparative chromatograph system 1 includes a liquid feeding pump 2, an autosampler 4, a separation column 6, a detector 8, a fraction collector 10, a column oven 12, a controller 14, and an information processing device 16.

The liquid feeding pump 2 feeds a mobile phase toward the separation column 6. The autosampler 4 is provided downstream of the liquid feeding pump 2 and injects a sample into the mobile phase fed by the liquid feeding pump 2. The separation column 6 time-separates a plurality of components in the sample injected into the mobile phase by the autosampler 4. The detector 8 is provided downstream of the separation column 6, and is for obtaining a chromatogram by outputting a signal having an intensity corresponding to the component concentration in an eluate from the separation column 6. The separation column 6 is accommodated in the column oven 12. The column oven 12 is a device for adjusting the temperature of the separation column 6 to a set temperature. The fraction collector 10 is a device that is provided with a plurality of collection containers 24 and drops a fraction of the eluate from the separation column 6 that has passed through the detector 8 from the nozzle 20 to the collection container 24 to collect the fraction. A three-way solenoid valve 22 is provided upstream of the nozzle 20. Switching of the three-way solenoid valve 22 can switch between guiding the eluate to the nozzle 20 and guiding the eluate to the drain.

The controller 14 is configured to control the operations of the liquid feeding pump 2, the autosampler 4, the detector 8, the fraction collector 10, and the column oven 12 according to a fractionation collecting condition given from the information processing device 16 to be described later, and to execute fractionation collecting of components in the sample. The controller 14 is realized by an electronic circuit device including a central processing part (CPU) and the like.

The information processing device 16 is a computer device communicably connected to the controller 14. The user sets a fractionation collecting condition on the information processing device 16. The fractionation collecting condition may include a flow rate of the mobile phase, a sample injection amount, an injection interval of stack injection, a column temperature, a purge time of the nozzle 20, a detection condition of a peak for fractionation collecting with waveform processing of the chromatogram, and a time program for fractionation collecting with a time program. The information processing device 16 transmits the fractionation collecting condition set by the user to the controller 14.

The information processing device 16 reads a signal output from the detector 8 through the controller 14 to create a chromatogram and performs detection of a peak appearing in the chromatogram, calculation of the retention time of each peak, and the like.

The information processing device 16 further includes a fractionation collecting condition correction part 18. The fractionation collecting condition correction part 18 is a function obtained by the CPU executing a program. The fractionation collecting condition correction part 18 determines whether there is a change in the chromatogram obtained by each injection of the sample during the execution of the stack injection fractionation collecting, that is, whether the chromatogram obtained by the current injection of the sample is changed from a reference chromatogram (for example, the chromatogram obtained by the first injection or the chromatogram obtained by the previous injection). When a change in the chromatogram is detected, the fractionation collecting condition correction part 18 corrects the fractionation collecting condition such that the chromatogram approaches the reference chromatogram.

Determination parameters such as retention time of a peak, height of a peak, peak width, and interval between peaks are used to determine whether a change has occurred in the chromatogram, and it can be determined that a change has occurred in the chromatogram when these determination parameters are different from that in the reference chromatogram by a predetermined rate or more.

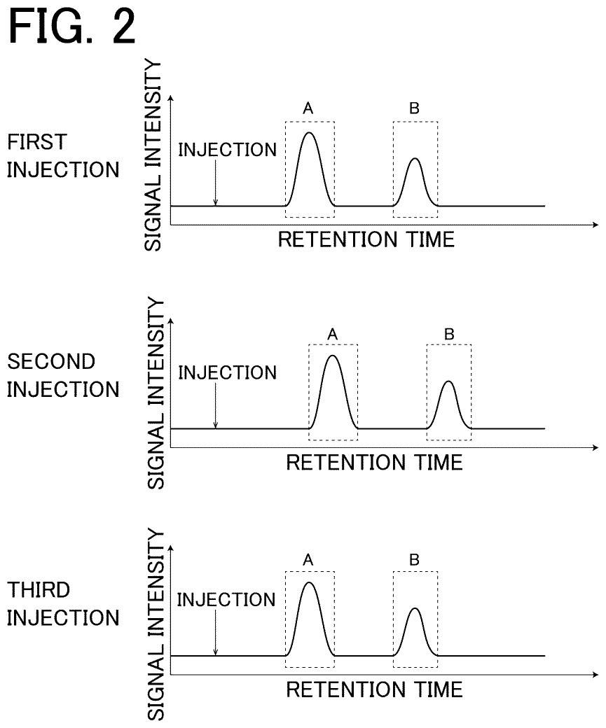

For example, as illustrated in FIG. 2, when the retention time of a peak of the chromatogram obtained by the second injection is delayed from the retention time of the same peak of the chromatogram obtained by the first injection by a predetermined rate or more, the fractionation collecting condition correction part 18 increases the flow rate of the mobile phase set as the fractionation collecting condition such that the retention time of the peak approaches that in the chromatogram obtained by the first injection. The information processing device 16 transmits the fractionation collecting condition set by the analysis condition collection part 18 to the controller 14. The controller 14 continues stack injection fractionation collecting using the corrected fractionation collecting condition. This makes it possible to cause the chromatogram obtained by the third injection to have a shape closer to the chromatogram obtained by the first injection than the chromatogram obtained by the second injection.

When a change is detected in any of the determination parameters, the correction of the fractionation collecting condition performed by the fractionation collecting condition correction part 18 can immediately be executed for the fractionation collecting condition associated with the changed determination parameter and be reflected in the control with the controller 14. In the example of FIG. 2, when it is detected that the retention time of a first peak A of the chromatogram obtained by the second injection is delayed from the retention time of the first peak of the chromatogram obtained by the first injection, the fractionation collecting condition correction part 18 can immediately increase the flow rate of the mobile phase. This makes it possible to advance the retention time of a second peak B of the chromatogram obtained by the second injection and to bring the chromatogram close to the chromatogram obtained by the first injection during the fractionation collecting of a component in the sample injected at the second time.

As another correction method, the fractionation collecting condition correction part 18 performs correction in such a manner as to increase the injection interval so that the component peaks of the sample injected at different timings do not overlap each other. The correction of the injection interval can be performed when the delay of the retention time of the peak is not eliminated through the correction of the flow rate of the mobile phase or the like.

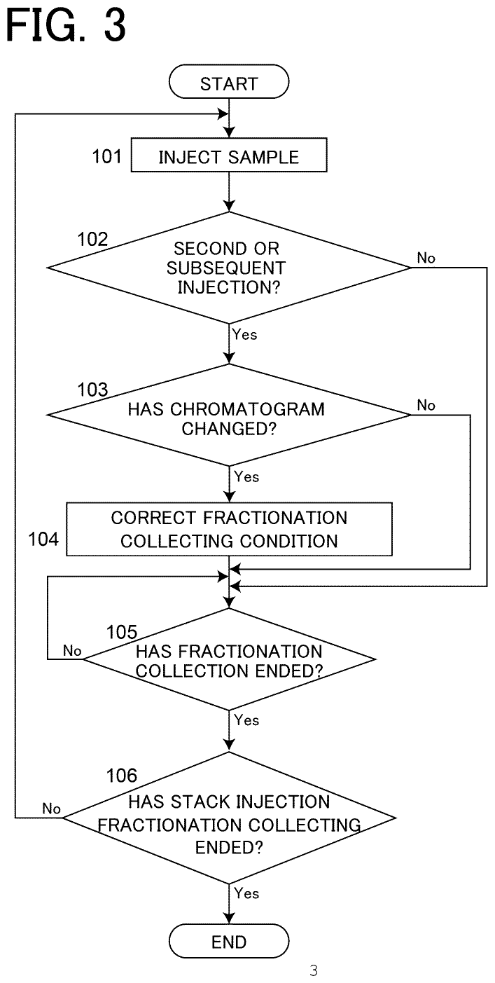

Next, an example of the operation of stack injection fractionation collecting with the preparative chromatograph system 1 will be described with reference to the flowchart of FIG. 3 together with FIG. 1.

When the user sets a fractionation collecting condition for stack injection fractionation collecting and inputs a start instruction to the information processing device 16, the fractionation collecting condition is transmitted from the information processing device 16 to the controller 14, and the controller 14 starts stack injection fractionation collecting according to the transmitted fractionation collecting condition.

In the stack injection fractionation collecting, the same sample is injected a plurality of times at an injection interval set as the fractionation collecting condition (step 101). In the first injection of the sample, fractionation collecting according to the set fractionation collecting condition is performed (step 105).

On the other hand, in the second and subsequent injections, the fractionation collecting condition correction part 18 determines whether the obtained chromatogram is changed from a reference chromatogram (step 103), and when a change in the chromatogram is detected (step 103: Yes), the fractionation collecting condition is corrected such that the chromatogram approaches the reference chromatogram (step 104). The corrected fractionation collecting condition is transmitted to the controller 14, and the controller 14 executes fractionation collecting according to the corrected fractionation collecting condition (step 105). In contrast, when the fractionation collecting condition correction part 18 has not detected a change in the chromatogram (step 103: No), the fractionation collecting continues without correction of the fractionation collecting condition (step 105). The above steps 101 to 105 are repeatedly performed until the number of injections of the sample reaches the set number of times, and the stack injection fractionation collecting ends when the number of injections of the sample reaches the set number of times (step 106).

Here, in the stack injection fractionation collecting, the position of the collection container 24 used for collecting each component, the capacity of each collection container 24, and the amount of the eluate collected in each collection container 24 are stored by the controller 14, whereby the same component can be continuously collected in the same collection container 24 until each collection container 24 is filled with the eluate. Then, when the collection container 24 in use is filled with the eluate, the collection of the corresponding component can be continued using a new empty collection container 24. Specifically, a collection container storage part that stores the number given to the collection container or the position information of the collection container collected for each peak of the chromatogram is provided. Then, when the collection container collecting the peak has become full, the number given to the collection container or the position information of the collection container stored in the collection container storage part is updated to the number given to the container to be used next or the position information of the container to be used next. This makes it possible to save the number of collection containers.

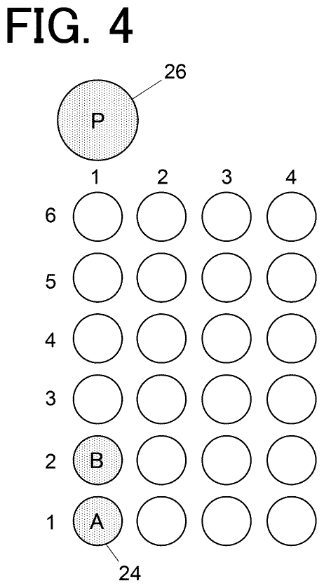

For example, when the fraction collector 10 is configured such that the collection containers 24 are arranged in a matrix of 6 rows×4 columns as illustrated in FIG. 4, and eluates respectively containing two components A and B contained in the sample are collected in the collection containers 24, the collection container 24 disposed at the position of 1-1 (the first column from the left in the first row from the bottom) can be continuously used until it becomes full for the collection of the component A eluted first from the separation column 6, and the collection container 24 disposed at the position of 2-1 (the first column from the left in the second row from the bottom) can be continuously used until it becomes full for the collection of the component B eluted second from the separation column 6. At this time, the collection container storage part stores that the component A is collected in the 1-1 (first) collection container and the component B is collected in the 2-1 (second) collection container.

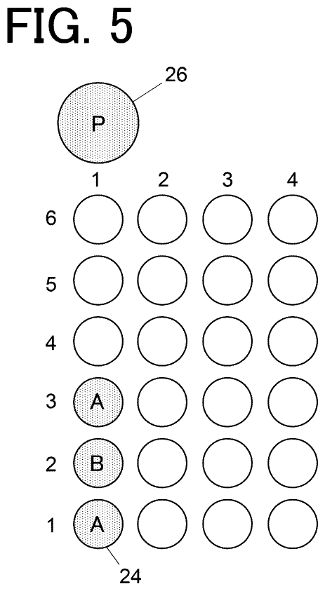

Then, for example, when the collection container 24 disposed at the position of 1-1 has become full, as illustrated in FIG. 5, a new empty collection container 24 (in the drawing, the collection container 24 disposed at the position of 3-1 (the first column of the third row)) can be used for collecting the component A. Further, when the collection container 24 disposed at the position of 2-1 has become full, a new empty collection container 24 (for example, the collection container 24 disposed at the position of 4-1 (the first column of the fourth row)) can be used for collecting the component B. At this time, the information stored in the collection container storage part is updated with information that the component A is collected in the 3-1 (third) collection container and the component B is collected in the 4-1 (fourth) collection container.

When the nozzle 20 is purged every time the fraction of the eluate is collected in the collection container 24, a specific position can be set as the purge position of the nozzle 20. In the examples of FIGS. 4 and 5, a drain port 26 is set as the purge position.

When the purge operation of the nozzle 20 is described with FIG. 4, the controller 14 drops the eluate containing the component A from the nozzle 20 to the collection container 24 disposed at the position of 1-1, then moves the nozzle 20 to the position of the drain port 26, and drops the eluate from the nozzle 20 to the drain port 26 for the purge time set as the fractionation collecting condition to purge the nozzle 20. Thereafter, the controller 14 moves the nozzle 20 to the position above the collection container 24 disposed at the position of 2-1, and drops the eluate containing the component B from the nozzle 20. After that, the controller 14 moves again the nozzle 20 to the position of the drain port 26, and drops the eluate from the nozzle 20 to the drain port 26 for the set purge time to purge the nozzle 20.

In addition to the drain port 26, the collection container 24 disposed at a specific position (for example, the position of the fourth column in the sixth row) among the plurality of collection containers 24 arranged in a matrix can be set as the purge position of the nozzle 20.

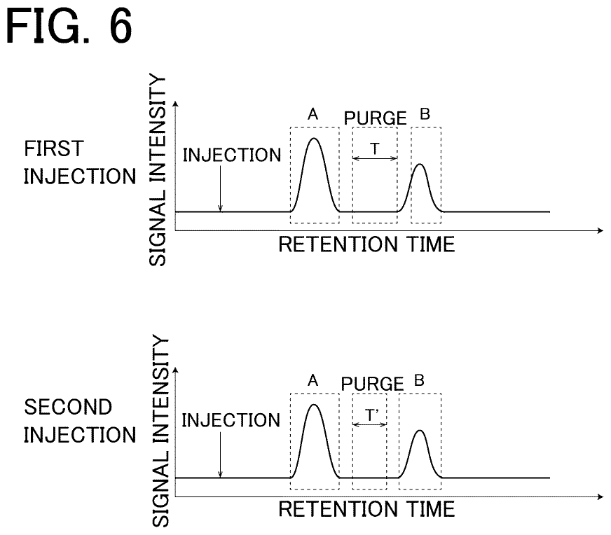

When the purge position is set at a specific position such as the drain port 26 as described above, depending on the length of the set purge time, there is a possibility that the movement of the nozzle 20 to the position where the component to be eluted next is supposed to be collected does not finish in time and collection of a part or all of the component fails. As illustrated in the upper diagram of FIG. 6, with a purge time of T seconds, if the nozzle 20 is moved to a predetermined purge position after the component A is collected in the collection container 24, and then the purge of the nozzle 20 is executed for T seconds, a part of the component B cannot be collected.

Thus, the fractionation collecting condition correction part 18 is configured to correct the purge time set for T seconds to a purge time of T′ seconds with which collection of each component of the sample injected at the second time or after the second time does not fail as illustrated in the lower diagram of FIG. 6 based on the moving time of the nozzle 20 and the interval between the peak of the component A and the peak of the component B in the chromatogram obtained by the first injection.

The embodiment described above is merely an example of the embodiments of the preparative chromatograph system according to the present invention. The embodiments of the preparative chromatograph system according to the present invention are as follows.

An embodiment of a preparative chromatograph system (1) according to the present invention includes:
a liquid feeding pump (2) that feeds a mobile phase;
an autosampler (4) that is provided downstream of the liquid feeding pump (2) and is configured to inject a sample into the mobile phase;
a separation column (6) provided downstream of the autosampler (4) for separating a plurality of components in the sample from each other;
a detector (8) provided downstream of the separation column (6) for obtaining a chromatogram of an eluate from the separation column (6);
a fraction collector (10) provided with a plurality of collection containers (24), the fraction collector (10) being configured to collect a fraction of the eluate from the separation column (6) in the collection containers (24);
a controller (14) configured to execute stack injection fractionation collecting of injecting a same sample a plurality of times at a time interval set in advance and fractionation collecting the components in the injected sample by controlling operations of the liquid feeding pump (2), the autosampler (4), and the fraction collector (10) according to a fractionation collecting condition set in advance; and
a fractionation collecting condition correction part (18) configured to detect a change in the chromatogram acquired in each of a plurality of injections of the sample during the stack injection fractionation collecting and correct the fractionation collecting condition during the stack injection fractionation collecting such that the chromatogram approaches a state before the change,
wherein the controller (14) is configured to continue the stack injection fractionation collecting based on the fractionation collecting condition that has been corrected after the fractionation collecting condition correction part (18) has corrected the fractionation collecting condition.

In aspect [1] of the embodiment of the preparative chromatograph system (1),
the fractionation collecting condition includes a flow rate of the mobile phase, and
the fractionation collecting condition correction part (18) is configured to correct the flow rate of the mobile phase such that a retention time of a peak appearing in the chromatogram of the sample injected at a second time or after the second time approaches a retention time of a corresponding peak in the chromatogram of the sample injected last time or before the last time.

In aspect [2] of the embodiment of the preparative chromatograph system (1),
the fractionation collecting condition includes an injection interval of the sample, and
the fractionation collecting condition correction part is configured to increase the injection interval when a retention time of a peak appearing in the chromatogram of the sample injected at a second time or after the second time is longer than a retention time of a same peak appearing in the chromatogram of the sample injected last time or before the last time.

This aspect [2] can be combined with the aspect [1].

In aspect [3] of the embodiment of the preparative chromatograph system (1), the controller (14) is configured to recognize an amount of the eluate collected in each of the plurality of collection containers (24) of the fraction collector in the stack injection fractionation collecting, to collect a same component in a same collection container (24) among the plurality of collection containers until the collection container (24) in use becomes full, and to use a new empty collection container (24) among the plurality of collection containers when the collection container (24) in use has become full.

This aspect [3] can be combined with the aspect [1] and/or [2].

In aspect [4] of the embodiment of the preparative chromatograph system (1),
the fraction collector (10) includes a nozzle (20) for dropping the fraction of the eluate to the collection container (24), and
the controller (14) is configured to drop the eluate to a purge position set at a specific position when a purge is performed on the nozzle (20).

This aspect [4] can be combined with the aspect [1], [2], and/or [3].

In the aspect [4], the controller (14) is configured to perform the purge on the nozzle (20) each time the fraction of the eluate corresponding to a peak portion of the chromatogram is collected in a collection container (24) among the plurality of the collection containers in the stack injection fractionation collecting,
the fractionation collecting condition includes a purge time for the purge of the nozzle (20), and
the fractionation collecting condition correction part (18) is configured to correct the purge time using a peak interval of the chromatogram of the sample injected at a first time in the stack injection fractionation collecting.

### DESCRIPTION OF REFERENCE SIGNS

1 preparative chromatograph system
2 liquid feeding pump
4 autosampler
6 separation column
8 detector
10 fraction collector
12 column oven
14 controller
16 information processing device
18 fractionation collecting condition setting part
20 nozzle
22 three-way solenoid valve
24 fraction collector

What is claimed is:

1. A preparative chromatograph system comprising:
a liquid feeding pump that feeds a mobile phase;
an autosampler that is provided downstream of the liquid feeding pump and is configured to inject a sample into the mobile phase;
a separation column provided downstream of the autosampler for separating a plurality of components in the sample from each other;
a detector provided downstream of the separation column for obtaining a chromatogram of an eluate from the separation column;
a fraction collector provided with a plurality of collection containers, the fraction collector being configured to collect fractions of the eluate from the separation column in the plurality of collection containers;
a controller configured to execute stack injection fractionation collecting of injecting a same sample a plurality of times at a time interval set in advance and fractionation collecting the components in the injected sample by controlling operations of the liquid feeding pump, the autosampler, and the fraction collector according to a fractionation collecting condition set in advance; and
a fractionation collecting condition correction part configured to detect a change in the chromatogram acquired in each of a plurality of injections of the sample during the stack injection fractionation collecting and to correct the fractionation collecting condition during the stack injection fractionation collecting such that the chromatogram approaches a state before the change,
wherein the controller is configured to continue the stack injection fractionation collecting based on the fractionation collecting condition that has been corrected after the fractionation collecting condition correction part has corrected the fractionation collecting condition.

2. The preparative chromatograph system according to claim 1, wherein
the fractionation collecting condition includes a flow rate of the mobile phase, and
the fractionation collecting condition correction part is configured to correct the flow rate of the mobile phase such that a retention time of a peak appearing in the chromatogram of the sample injected at a second time or after the second time approaches a retention time of a corresponding peak in the chromatogram of the sample injected last time or before the last time.

3. The preparative chromatograph system according to claim 1, wherein
the fractionation collecting condition includes an injection interval of the sample, and
the fractionation collecting condition correction part is configured to increase the injection interval when a retention time of a peak appearing in the chromatogram of the sample injected at a second time or after the second time is longer than a retention time of a same peak appearing in the chromatogram of the sample injected last time or before the last time.

4. The preparative chromatograph system according to claim 1, wherein the controller is configured to recognize an amount of the eluate collected in each of the plurality of collection containers of the fraction collector in the stack injection fractionation collecting, to collect a same component in a same collection container among the plurality of collection containers until the collection container in use becomes full, and to use a new empty collection container among the plurality of collection containers when the collection container in use has become full.

5. The preparative chromatograph system according to claim 1, wherein
the fraction collector includes a nozzle for dropping the fraction of the eluate to the collection container, and
the controller is configured to drop the eluate to a purge position set at a specific position when a purge is performed on the nozzle.

6. The preparative chromatograph system according to claim 5, wherein
the controller is configured to perform the purge on the nozzle each time the fraction of the eluate corresponding to a peak portion of the chromatogram is collected in a collection container among the plurality of the collection containers in the stack injection fractionation collecting,
the fractionation collecting condition includes a purge time for the purge of the nozzle, and
the fractionation collecting condition correction part is configured to correct the purge time using a peak interval of the chromatogram of the sample injected at a first time and a moving time of the nozzle in the stack injection fractionation collecting.
